(19) United States
(12) Patent Application Publication
(10) Pub. No.: US 2002/0116470 A1
(43) Pub. Date: Aug. 22, 2002

(54) Document distribution system and method

(76) Inventors: Daniel J. Dyer, Boise, ID (US); Darrel D. Cherry, Meridian, ID (US); Garth F. Schmeling, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/789,322

(22) Filed: Feb. 20, 2001

(51) Int. Cl. G06F 15/16

(52) U.S. Cl. 709/217; 709/202

(57) ABSTRACT

A system and method for distributing a document to a user includes a document distribution system controller having a document criterion of the user registered therewith. The document distribution system controller receives the document and determines if the document satisfies the document criterion of the user by comparing the document with the document criterion. If the document distribution system controller determines that the document satisfies the document criterion of the user, the document distribution system controller distributes the document to the user.

### THE FIELD OF THE INVENTION

The present invention relates generally to document services and, more particularly, to a system and method for automatically distributing a document to a user when the document becomes available.

### BACKGROUND OF THE INVENTION

Typically, a user seeking electronically published information about a specific subject must access a system, such as a search engine or database index, which includes links to a variety of documents or postings about numerous subjects. The user must then manually initiate a search by formulating and submitting a search strategy, including a search criterion such as keywords and/or logic rules, to the system.

Such a search, however, will only discover those documents which have already been registered or posted with the system. Understandably, any documents which are registered or posted to the system after such a search is performed will not be discovered unless the user re-searches the system with the same search criterion. Thus, to keep abreast of new documents related to the specific subject of interest to the user, the user must routinely or periodically re-search the system.

Unfortunately, routinely or periodically re-searching the system for documents which are of interest to the user is a laborious task. The user, for example, must maintain search strategies used for prior searches to be able to replicate such prior searches in the future. Thus, to replicate prior searches, the user must re-enter or, more specifically, re-formulate and re-submit the search strategy. In addition, the user, must also maintain results of prior searches to be able to disregard those documents previously identified by such prior searches. Furthermore, the user generally cannot dictate the manner in which documents identified by such searches are distributed to the user.

Accordingly, a need exists for automatically distributing a document to a user when the document becomes available. More particularly, a need exists for automatically distributing the document to the user if the document satisfies criterion of the user. In addition, a need exists for automatically distributing the document to the user in a manner preferred by the user.

### SUMMARY OF THE INVENTION

One aspect of the present invention provides a method of distributing a document to a user. The method includes registering a document criterion of the user, receiving the document, determining if the document satisfies the document criterion of the user, and distributing the document to the user if the document satisfies the document criterion of the user. The step of determining if the document satisfies the document criterion of the user includes comparing the document with the document criterion of the user.

Another aspect of the present invention provides a computer-readable medium having computer-executable instructions for performing a method of distributing a document to a user. The method includes registering a document criterion of the user, receiving the document, determining if the document satisfies the document criterion of the user, and distributing the document to the user if the document satisfies the document criterion of the user. Determining if the document satisfies the document criterion of the user includes comparing the document with the document criterion of the user.

Another aspect of the present invention provides a system for distributing a document to a user. The system includes a document distribution system controller configured to have a document criterion of the user registered therewith. As such, the document distribution system controller is adapted to receive the document and compare the document with the document criterion of the user to determine if the document satisfies the document criterion of the user. Thus, the document distribution system controller is adapted to distribute the document to the user if the document distribution system controller determines that the document satisfies the document criterion of the user.

In one embodiment, the present invention provides a system and method for automatically distributing a document to a user when the document becomes available. The system and method compares the document with document criterion of the user to determine if the document should be distributed to the user.

### BRIEF DESCRIPTION OF THE DRAWINGS

FIG. 1 is a block diagram illustrating one exemplary embodiment of a document distribution system according to the present invention.

FIG. 2 is a block diagram illustrating one exemplary embodiment of registration by a user with the document distribution system of FIG. 1.

FIG. 3 is a diagram illustrating one exemplary embodiment of a document criterion of a user registered with the document distribution system of FIG. 1.

FIG. 4 is a diagram illustrating one exemplary embodiment of a distribution preference of a user registered with the document distribution system of FIG. 1.

FIG. 5 is a block diagram illustrating one exemplary embodiment of distribution of a document to a user of the document distribution system of FIG. 1.

FIG. 6 is a flow diagram illustrating one exemplary embodiment of a method of distributing a document to a user according to the present invention.

FIG. 7 is a flow diagram illustrating one exemplary embodiment of comparing the document with document criterion of the user in the method of FIG. 6.

FIG. 8 is a flow diagram illustrating another exemplary embodiment of comparing the document with document criterion of the user in the method of FIG. 6.

FIG. 9 is a flow diagram illustrating one exemplary embodiment of distributing the document to the user in the method of FIG. 6.

FIG. 10 is a flow diagram illustrating another exemplary embodiment of distributing the document to the user in the method of FIG. 6.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

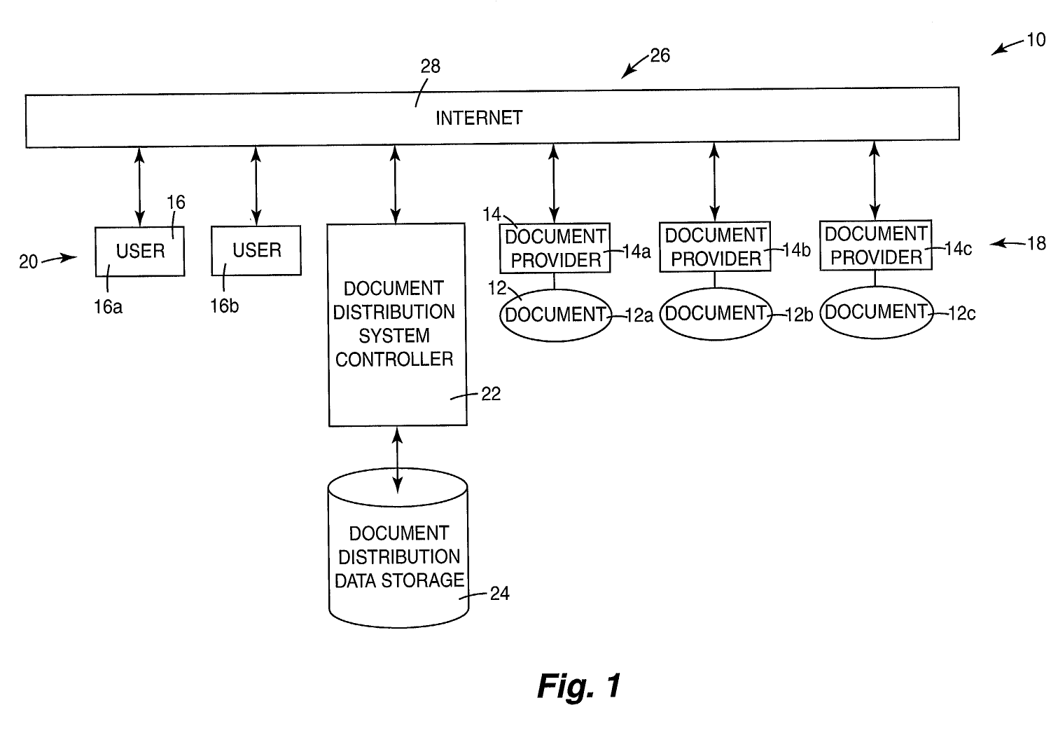

A document distribution system according to the present invention is illustrated generally at 10 in FIG. 1. Document distribution system 10 facilitates distribution of a document 12 of a document provider 14 to a user 16. In particular, document distribution system 10 automatically distributes a document 12a, 12b, 12c of a respective document provider 14a, 14b, 14c to at least one user 16a, 16b registered with document distribution system 10. For clarity, document 12a, 12b, 12c, document provider 14a, 14b, and user 16a, 16b are referred to hereinafter as document 12, document provider 14, and user 16, respectively. As such, document provider 14 may be one of a plurality of document providers 18, each providing a respective document 12. In addition, user 16 may be one of a plurality of users 20 each registered with and, thereby, utilizing document distribution system 10.

Document 12, as used herein, is defined to include any information presented in textural and/or graphical form. Document provider 14, as used herein, is defined to include an entity or system offering, providing, publishing, and/or posting a document to document distribution system 10. User 16, as used herein, is defined to include an entity or system requesting or soliciting a document through document distribution system.

Document distribution system 10 includes a document distribution system controller 22 which coordinates and/or manages distribution of documents 12 to users 20. More specifically, document distribution system controller 22 collects user criterion and user preferences for documents 12, processes documents 12, matches documents 12 with user criterion, and distributes matching documents 12 to users 20 per user preferences, as described below.

Document distribution system controller 22 includes hardware, software, firmware, or a combination of these. In one preferred embodiment, document distribution system controller 22 includes a computer server or other microprocessor-based system capable of performing a sequence of logic operations. In addition, document distribution system controller 22 can include a microprocessor embedded system/appliance incorporating tailored appliance hardware and/or dedicated single purpose hardware.

In one exemplary embodiment, document distribution system 10 includes a document distribution data storage system 24. Document distribution data system 24 constitutes a database of one or more data files for document distribution system 10. Examples of document distribution data storage system 24 include non-volatile memory (e.g., a hard disk drive or other persistent storage device) and may include volatile memory (e.g., random access memory (RAM)). Another example of document distribution data storage system 24 may include a relational database management server (RDBMS). Data is transferred to and from document distribution data storage system 24 via document distribution system controller 22.

Document providers 18, users 20, and document distribution system controller 22 communicate with each other via a communication link 26. Communication link 26, as used herein, is defined to include an internet communication link, an intranet communication link, or similar high-speed communication link including a wireless communication link. In one preferred embodiment, communication link 26 includes an Internet communication link 28.

In one exemplary embodiment, document providers 18, users 20, and document distribution system controller 22 are all located remote from each other (i.e., at different locations). Thus, communications between document providers 18 and document distribution system controller 22, communications between users 20 and document distribution system controller 22, and communications between document providers 18 and users 20 are conducted over communication link 26. Preferably, document providers 18 and/or users 20 communicate with document distribution system controller 22 via Internet communication link 28. It is, however, within the scope of the present invention for document providers 18 and/or users 20 to communicate with document distribution system controller 22 in other manners (e.g., a direct connection).

Document distribution system 10, including document distribution system controller 22, can be implemented in hardware via a microprocessor, programmable logic device, or state machine, in firmware, or in software within a given device. In one aspect, at least a portion of the software programming is written in JAVA programming language, and each of the main components communicate via Internet communication link 28 using a communication bus protocol. For example, the present invention may or may not use a TCP/IP protocol suite for data transport. Other programming languages and communication bus protocols suitable for use with document distribution system 10 will become apparent to those skilled in the art after reading the present application.

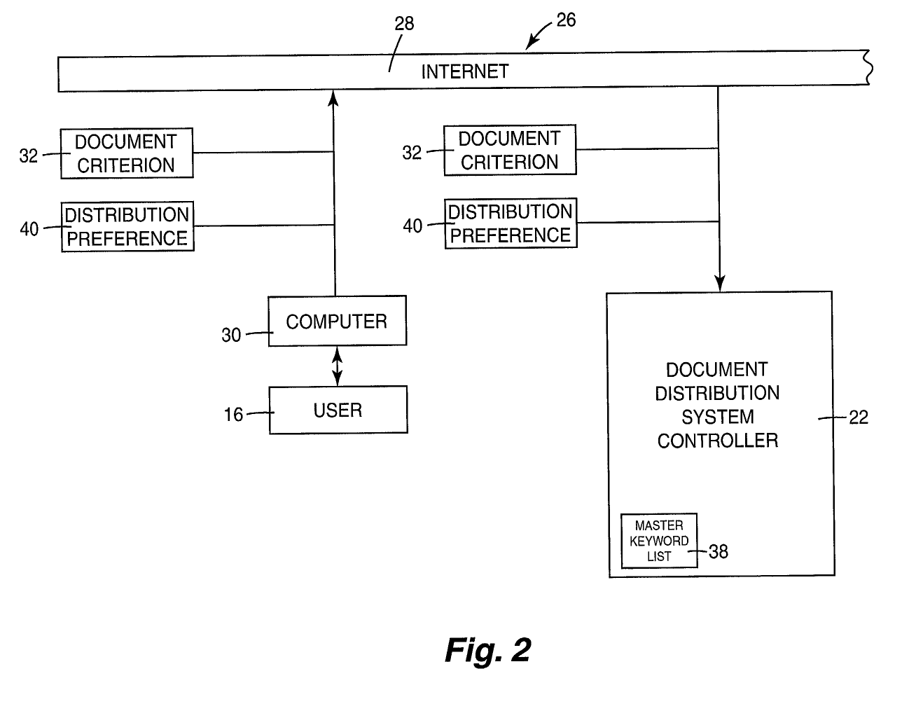

As illustrated in FIG. 2, user 16 interacts with a computer 30 to register a document criterion 32 for matching documents with document distribution system 10. Document criterion 32 identifies a type of document in which user 16 is interested. Document criterion 32 is based, for example, on a topic, a subject matter, an origin, and/or an intended audience of document 12, as described below. Preferably, user 16 submits document criterion 32 to document distribution system controller 22 via communication link 26.

In one exemplary embodiment, computer 30 runs an operating system which can support one or more applications. The operating system is stored in memory and executes on a processor. The operating system is preferably a multi-tasking operating system which allows simultaneous execution of multiple applications, although aspects of the present invention may be implemented using a single tasking operating system. Computer 30 may include, for example, an input device such as a keyboard and/or a mouse and a display device such as a monitor, as is well known in the art. Computer 30 may be an appliance such as a personal digital assistant (PDA), scanner, camera, cellular phone, etc.

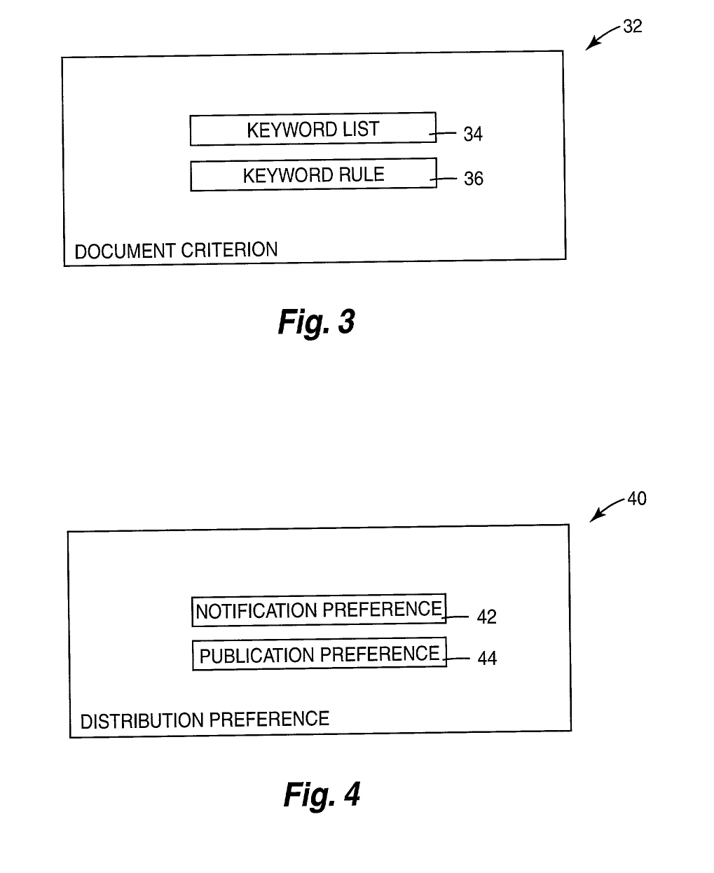

In one exemplary embodiment, as illustrated in FIG. 3, document criterion 32 includes a keyword list 34 of user 16 and a keyword rule 36 of user 16. Keyword list 34 identifies one or more words, abbreviations, character strings, etc. which are of interest to user 16. Keyword rule 36 combines one or more words, abbreviations, character strings, etc. from keyword list 34 with a logical operator. An example of a logical operator includes a Boolean operator or expression such as “AND”, “OR”, “NOT”, etc. It is also within the scope of the present invention for document criterion 32 to be specified using a “Natural Language” expression. Thus, with keyword list 34 and/or keyword rule 36, which documents 12 are to be automatically distributed to user 16 is defined.

Returning to FIG. 2, in one exemplary embodiment, document distribution system controller 22 maintains a master keyword list 38. Master keyword list 38 is based on document criterion 32 and, more specifically, keyword list 34 and/or keyword rule 36. As such, master keyword list 38 includes a listing of words, abbreviations, character strings, etc. included in keyword list 34 and/or keyword rule 36 as registered by user 16.

Document distribution system controller 22 updates master keyword list 38 as necessary when new document criterion 32 is registered with document distribution system 10. Thus, document keyword list 50 is automatically maintained by document distribution system controller 22. In one exemplary embodiment, document distribution system controller 22 refers to master keyword list 38 when determining which documents 12 are to be distributed to which users 20, as described below.

In one exemplary embodiment, as illustrated in FIG. 2, user 16 interacts with computer 30 to register a distribution preference 40 for matching documents with document distribution system 10. Distribution preference 40 identifies a manner in which a matching document 12 is to be distributed to user 16. Preferably, user 16 submits distribution preference 40 to document distribution system controller 22 via communication link 26. It is understood that user 16 may register multiple document criterion 32 with document distribution system controller 22. As such, user 16 may register the same and/or different distribution preferences 40 with each document criterion 32.

In one exemplary embodiment, as illustrated in FIG. 4, distribution preference 40 includes a notification preference 42 of user 16 and a publication preference 44 of user 16. Notification preference 42 specifies whether and how user 16 is to be notified when document 12 matches document criterion 32 of user 16. An example of notification preference 42 includes receiving an electronic mail message (i.e., an e-mail) notifying user 16 of document 12. Publication preference 44 specifies whether and how document 12 is to be published for user 16 when document 12 matches document criterion 32 of user 16. Examples of publication preference 44 include printing of document 12 for user 16 and/or displaying of document 12 on computer 30 for user 16. Thus, with notification preference 42 and/or publication preference 44, how documents 12 are to be automatically distributed to user 16 is defined.

In one exemplary embodiment, document distribution system controller 22 communicates with and transfers document criterion 32 of user 16 and/or distribution preference 40 of user 16 to document distribution data storage system 24 (FIG. 1). As such, document distribution system controller 22 stores document criterion 32 and/or distribution preference 40 in document distribution data storage system 24 for subsequent retrieval, processing, and distribution. More specifically, when document distribution system controller 22 receives document criterion 32 and/or distribution preference 40 from user 16, document criterion 32 and/or distribution preference 40 is stored as a data file in document distribution data storage system 24. Document distribution system controller 22, therefore, subsequently retrieves document criterion 32 and/or distribution preference 40 from document distribution data storage system 24 for processing. Thus, document distribution data storage system 24 maintains document criterion 32 and/or distribution preference 40 of user 16.

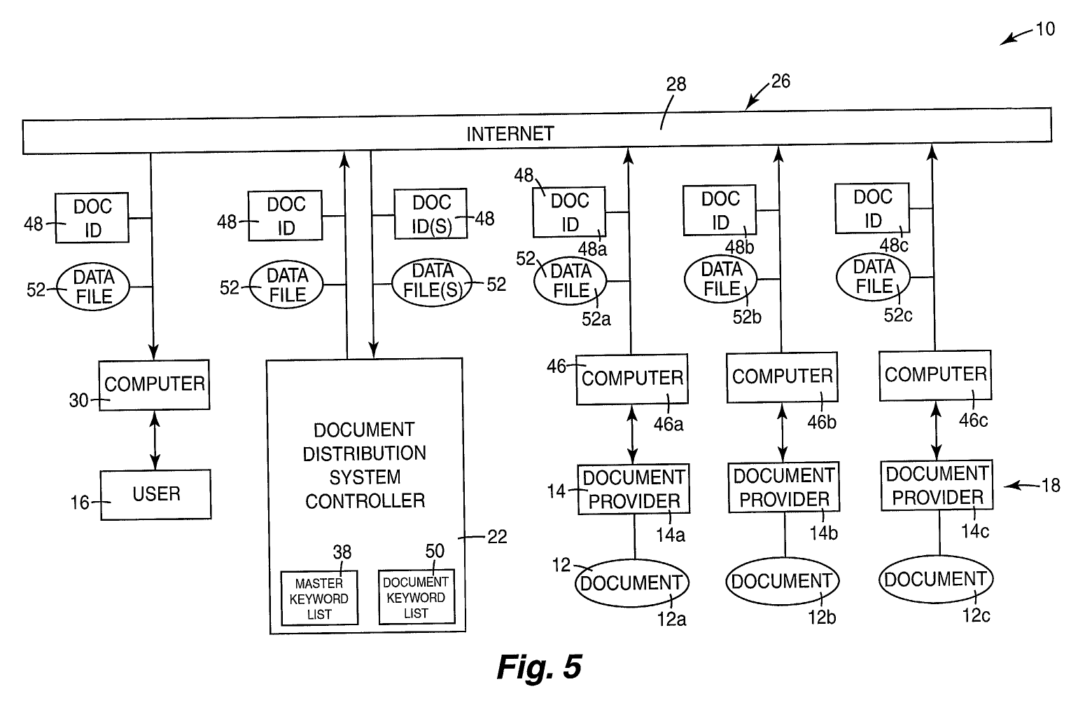

As illustrated in FIG. 5, each document provider 14a, 14b, 14c interacts with a respective computer 46a, 46b, 46c to submit a respective document 12a, 12b, 12c to document distribution system 10. For clarity, computer 46a, 46b, 46c is referred to hereinafter as computer 46. Computer 46 may include, for example, an input device such as a keyboard and/or a mouse and a display device such as a monitor, as is well known in the art. Computer 46 may be an appliance such as a personal digital assistant (PDA), scanner, camera, cellular phone, etc. Computer 46 may run an operating system which can support one or more applications, similar to that described above with regards to computer 30.

In one exemplary embodiment, document providers 14a, 14b, 14c submit a respective document identification 48a, 48b, 48c for a respective document 12a, 12b, 12c to document distribution system controller 22 via communication link 26. For clarity, document identification 48a, 48b, 48c is referred to hereinafter as document identification 48. Document identification 48 includes, for example, a title, an author/publisher, and/or a subject matter of document 12.

In one exemplary embodiment, document identification 48 includes file location information for document 12 such as a uniform resource locator (URL) for document 12. As such, document distribution system controller 22 retrieves and processes document 12. More specifically, document distribution system controller 22 compares document 12 with master keyword list 38 and generates a document keyword list 50 for document 12. Document keyword list 50 includes a list of keywords from master keyword list 38 which are present in a respective document 12. Thus, document distribution system controller 22 automatically processes and generates document keyword list 50 for new documents 12 submitted to document distribution system 10.

In one exemplary embodiment, document providers 14a, 14b, 14c submit a respective data file 52a, 52b, 52c for a respective document 12a, 12b, 12c to document distribution system controller 22 via communication link 26. For clarity, data file 52a, 52b, 52c is referred to hereinafter as data file 52. In one preferred embodiment, document distribution system controller 22 processes data file 52 for document 12 and determines a content of document 12 from data file 52. Thus, document distribution system controller 22 generates document keyword list 50 for document 12 from data file 52.

It is, however, within the scope of the present invention for document keyword list 50 to be created by document provider 14 and submitted, along with document identification 48 and/or data file 52, to document distribution system controller 22 via communication link 26. As such, document keyword list 50 includes a list of keywords which identify a content of document 12, including a topic, a subject matter, an origin, and/or an intended audience of document 12.

In one exemplary embodiment, document keyword list 50 is associated with document identification 48 and/or data file 52. As such, document keyword list 50 along with document identification 48 and/or data file 52 are stored in document distribution data storage system 24 (FIG. 1). Document distribution system controller 22, therefore, subsequently retrieves document keyword list 50 along with document identification 48 and/or data file 52 from document distribution data storage system 24 for processing, as described below.

According to the present invention, document distribution system controller 22 automatically distributes document 12 to user 16 based on document criterion 32 of user 16. More specifically, document distribution system controller 22 distributes document 12 to user 16 if document 12 satisfies document criterion 32 of user 16. Thus, document distribution system controller 22 manages distribution of document 12 to user 16. It is understood that document distribution system controller 22 may receive, process, and distribute one or more documents 12 of one or more document providers 18 to one or more users 20 registered with document distribution system 10.

In one exemplary embodiment, as illustrated in FIG. 5, document distribution system controller 22 automatically distributes document 12 to user 16. Preferably, distribution system controller 22 distributes document 12 to user 16 when document 12 becomes available. More specifically, document distribution system controller 22 distributes document 12 to user 16 when document 12 is submitted to document distribution system controller 22.

To determine which documents 12 are to be distributed to which users 20, document distribution system controller 22 compares document 12 with document criterion 32 of user 16. As such, document distribution system controller 22 compares document 12 with master keyword list 38 which, as described above, is based on document criterion 32. Since document keyword list 50 for document 12 is based on a content of document 12 and master keyword list 38, document distribution system controller 22 can compare document keyword list 50 for document 12 with document criterion 32 of user 16. In addition, since document criterion 32 is based on keyword list 34 and/or keyword rule 36, document distribution system controller 22 can compare document keyword list 50 for document 12 with keyword list 34 and/or keyword rule 36 of user 16.

Thus, if document distribution system controller 22 determines that document 12 satisfies document criterion 32 of user 16, document distribution system controller 22 distributes document 12 to user 16. In one exemplary embodiment, document distribution system controller 22 distributes document identification 48 for document 12 and/or data file 52 for document 12 to user 16 via communication link 26 and computer 30.

In one preferred embodiment, document distribution system controller 22 distributes document 12 to user 16 in accordance with distribution preference 40 of user 16, as registered with document distribution system controller 22. More specifically, document distribution system controller 22 distributes document 12 to user 16 in accordance with notification preference 42 of user 16 and/or publication preference 44 of user 16.

If, for example, notification preference 42 specifies notification of user 16 by an electronic mail message, document distribution system controller 22 sends an electronic mail message to user 16 via communication link 26 and computer 30. The electronic mail message may include, for example, document identification 48 for document 12. As described above, document identification 48 for document 12 may include file location information for document 12 such as a uniform resource locator (URL) for document 12. Thus, user may access document 12 by entering the file location information.

If, for example, publication preference 44 specifies publication of document 12 for user 16, document distribution system controller 22 sends data file 52 of document 12 to user 16 via communication link 26 and computer 30. As such, data file 52 may be processed and displayed on a display device associated with computer 30 and/or printed by a printing device associated with computer 30. Thus, document 12 is made available to user 16.

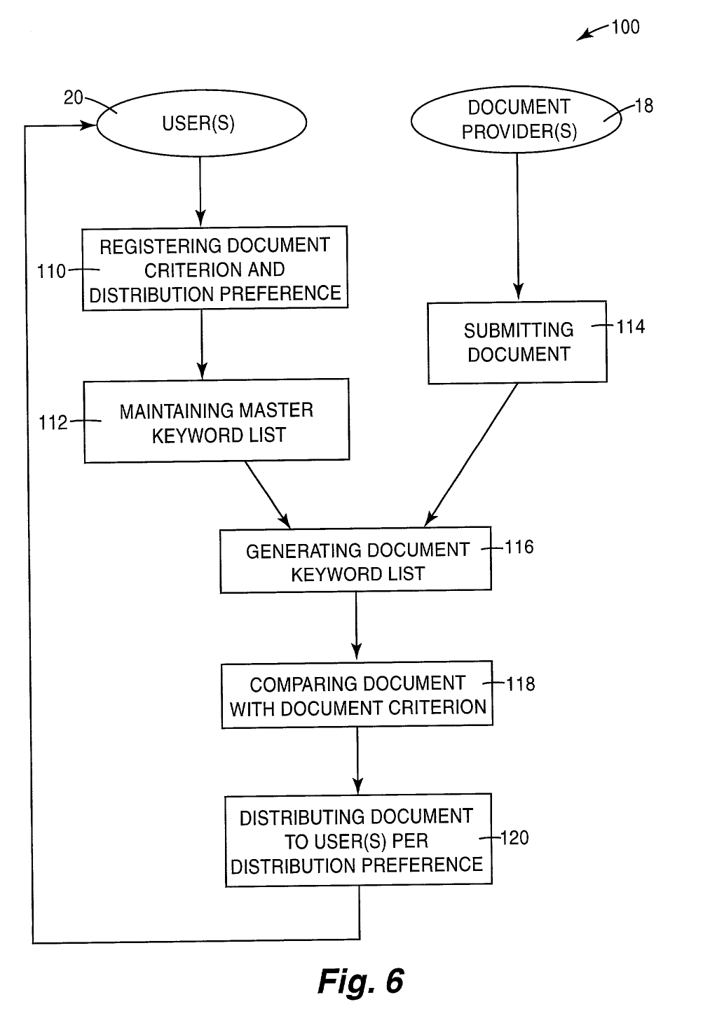

In FIG. 6, a flow diagram illustrating one exemplary embodiment of a method of distributing document 12 to user 16 according to the present invention is illustrated generally at 100. Reference is also made to FIGS. 1-5. At step 110, at least one user 16 of the plurality of users 20 registers a respective document criterion 32 for matching documents with document distribution system controller 22 and, in one exemplary embodiment, registers a respective distribution preference 40 for matching documents with document distribution system controller 22. More specifically, user 16 registers keyword list 34 and/or keyword rule 36 with document distribution system controller 22 and notification preference 42 and/or publication preference 44 with document distribution system controller 22. In one exemplary embodiment, user 16 registers document criterion 32 and distribution preference 40 with document distribution system controller 22 via communication link 26, as illustrated in FIG. 2.

At step 112, after document distribution system controller 22 receives document criterion 32, document distribution system controller 22 maintains master keyword list 38. More specifically, document distribution system controller 22 creates and/or updates master keyword list 38 based on keywords included in keyword list 34 and/or keyword rule 36 of user 16, as registered in step 110. Thus, if document distribution system controller 22 is creating master keyword list 38, document distribution system controller 22 extracts keywords from keyword list 34 and/or keyword rule 36. If, however, document distribution system controller 22 is updating master keyword list 38, for example, in response to new document criterion 32, document distribution system controller 22 compares keywords from keyword list 34 and/or keyword rule 36 with master keyword list 38. As such, document distribution system controller 22 updates master keyword list 38 to include any new keywords.

At step 114, at least one document provider 14 of the plurality of document providers 18 submits a respective document 12 to document distribution system controller 22. More specifically, document provider 14 submits document identification 48 for document 12 and/or data file 52 for document 12 to document distribution system controller 22. In one exemplary embodiment, document provider 14 submits document 12 to document distribution system controller 22 via communication link 26, as illustrated in FIG. 5.

Next, in step 116, document distribution system controller 22 generates document keyword list 50. Document distribution system controller 22 generates document keyword list 50 by comparing document 12 with master keyword list 38. Thus, document distribution system controller 22 identifies which keywords from master keyword list 38 and, therefore, document criterion 32 of users 20 are included in document 12. Step 116 can be initiated in response to a new document being submitted to document distribution system 10, as described above with regards to step 114, and/or a new keyword being added to master keyword list 38, as described above with regards to step 112.

Next, in step 118, after document distribution system controller 22 receives document 12, document distribution system controller 22 manages distribution of document 12. More specifically, document distribution system controller 22 determines to which user 16 document 12 is to be distributed. As such, document distribution system controller 22 compares document 12 with document criterion 32 of users 20 to determine if document 12 satisfies document criterion 32 of one or more users 20. Document distribution system controller 22, therefore, effectively filters which documents are to be distributed to user 16. Thus, document distribution system 10 enables user 16 to subscribe to and receive only those documents which satisfy document criterion 32.

Then, in step 120, document distribution system controller 22 distributes document 12 to user 16 if document 12 satisfies document criterion 32 of user 16, as determined in step 118. Distribution of document 12 to user 16 includes distribution of document identification 48 for document 12 and/or distribution of data file 52 for document 12 to user 16, as illustrated in FIG. 5. It is understood that document distribution system controller 22 may distribute document 12 to one or more users 20 if document 12 satisfies document criterion 32 of one or more users 20.

Preferably, user 16 registers document criterion 32 and distribution preference 40 at step 110 before document provider 14 submits document 12 at step 114. Comparison of document 12 with document criterion 32 in step 118, therefore, includes comparison of those documents submitted to document distribution system controller 22 after user 16 registers document criterion 32.

It is understood, however, that when user 16 initially registers document criterion 32 at step 110, document distribution system controller 22 can compare document criterion 32 with those documents already registered with document distribution system 10. Thus, comparison of document 12 with document criterion 32 in step 118 can initially include comparison of document criterion 32 with those documents which are already registered with document distribution system 10 and distribution of document 12 to user 16 in step 120 can initially include distribution of one or more documents which are already registered with document distribution system 10 and which satisfy document criterion 32. Subsequent comparison in step 118 and distribution in step 120, however, includes comparison and distribution of documents submitted to document distribution system controller 22 after user 16 initially registers with document distribution system 10.

In addition, it is within the scope of the present invention for user 16 to re-register and/or update document criterion 32 and/or distribution preference 40. As such, document distribution system controller 22 can re-compare document criterion 32 of user 16 with those documents which are already registered with document distribution system 10 and re-distribute to user 16, in accordance with distribution preference 40, those documents which satisfy document criterion 32. Thus, any new input, such as document criterion 32 and/or distribution preference 40 as well as document 12, can initiate comparison and distribution of documents by document distribution system controller 22.

When document criterion 32 and, in one exemplary embodiment, distribution preference 40 of user 16 are registered with document distribution system controller 22 in step 110, document distribution system controller 22 stores document criterion 32 and distribution preference 40 in document distribution data storage system 24, as described above. As such, document distribution system controller 22 retrieves document criterion 32 from document distribution data storage system 24 when comparing document 12 with document criterion 32 in step 118 and retrieves distribution preference 40 from document distribution data storage system 24 when distributing document 12 to user 16 in step 120.

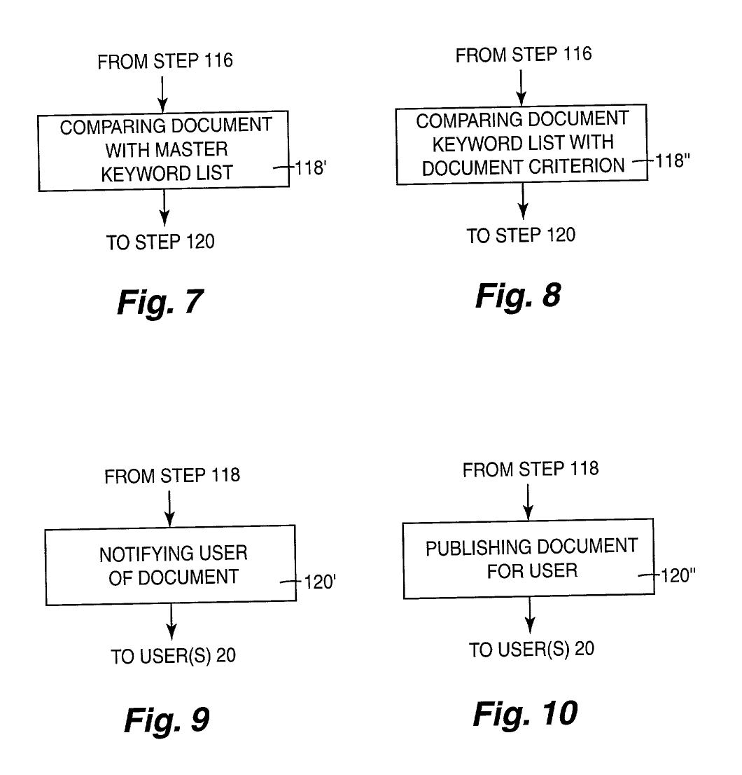

As illustrated in FIG. 7, one exemplary embodiment of the step of comparing document 12 with document criterion 32 in step 118 includes comparing document 12 with master keyword list 38, as indicated in step 118′. As such, document distribution system controller 22 determines whether document 12 includes any keywords from master keyword list 38. If so, document distribution system controller 22 may distribute document 12 to user 16, as indicated in step 120.

As illustrated in FIG. 8, another exemplary embodiment of the step of comparing document 12 with document criterion 32 in step 118 includes comparing document keyword list 50 with document criterion 32, as indicated in step 118″. As such, document distribution system controller 22 determines whether keywords from document keyword list 50 of document 12 satisfy document criterion 32 and, more specifically, keyword list 34 and/or keyword rule 36 of user 16. If so, document distribution system controller 22 may distribute document 12 to user 16, as indicated in step 120.

As illustrated in FIG. 9, one exemplary embodiment of the step of distributing document 12 to user 16 in step 120 includes distributing document 12 to user 16 in accordance with notification preference 42. More specifically, distributing document 12 to user 16 in step 120 includes notifying user 16 of document 12, as indicated in step 120′. Thus, user 16 is notified that document 12 satisfies document criterion 32, as described above.

As illustrated in FIG. 10, another exemplary embodiment of the step of distributing document 12 to user 16 in step 120 includes distributing document 12 to user 16 in accordance with publication preference 44. More specifically, distributing document 12 to user 16 in step 120 includes publishing document 12 for user 16, as indicated in step 120″. Thus, document 12 is published for user 16, as described above.

In one exemplary embodiment, steps 110-120 of method 100 are performed via computer-executable instructions of a computer-readable medium. Computer-readable medium, as used herein, is defined to include any kind of computer memory such as a floppy disk, conventional hard disk, CD-ROM, Flash ROM, nonvolatile ROM, RAM, etc.

By registering with document distribution system 10, user 16 can automatically receive documents 12 that are of interest to user 16. More specifically, by registering document criterion 32 which defines an interest of user 16 with document distribution system controller 22, user 16 can automatically receive documents 12 which satisfy document criterion 32 as such documents are registered with document distribution system 10. Document distribution system 10, therefore, facilitates distribution of documents 12 to those users 20 who are interested in such documents. Thus, it is not necessary for user 16 to routinely or periodically search for documents of interest since document distribution system 10 automatically distributes such documents to user 16 when such documents become available. In addition, by defining communication link 26 between document providers 18, users 20, and document distribution system controller 22, documents 12 can be efficiently and automatically distributed from document providers 18 to users 20.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A method of distributing a document to a user, the method comprising the steps of:
registering a document criterion of the user;
receiving the document;
determining if the document satisfies the document criterion of the user, including comparing the document with the document criterion of the user; and
distributing the document to the user if the document satisfies the document criterion of the user.

2. The method of claim 1, wherein the step of determining if the document satisfies the document criterion includes comparing a content of the document with the document criterion of the user.

3. The method of claim 1, wherein the step of registering the document criterion includes registering the document criterion of the user with a document distribution system controller, wherein the step of receiving the document includes receiving the document at the document distribution system controller, and wherein the step of determining if the document satisfies the document criterion includes determining via the document distribution system controller if the document satisfies the document criterion of the user.

4. The method of claim 3, further comprising the step of:
defining a communication link between the user and the document distribution system controller, and wherein the step of registering the document criterion includes registering the document criterion of the user with the document distribution system controller via the communication link.

5. The method of claim 4, wherein the step of defining the communication link includes defining an Internet communication link between the user and the document distribution system controller, and wherein the step of registering the document criterion includes registering the document criterion of the user with the document distribution system controller via the Internet communication link.

6. The method of claim 3, wherein the step of registering the document criterion includes registering at least one of a keyword list of the user and a keyword rule of the user with the document distribution system controller, and further comprising the step of:
maintaining via the document distribution system controller a master keyword list based on the at least one of the keyword list of the user and the keyword rule of the user, and wherein the step of determining if the document satisfies the document criterion includes comparing the document with the master keyword list.

7. The method of claim 6, further comprising the step of:
generating via the document distribution system controller a document keyword list for the document based on a content of the document and the master keyword list, and wherein the step of determining if the document satisfies the document criterion includes comparing the document keyword list with the document criterion.

8. The method of claim 3, further comprising the step of:
defining a communication link between a document provider and the document distribution system controller, and wherein the step of receiving the document includes receiving the document at the document distribution system controller from the document provider via the communication link.

9. The method of claim 8, wherein the step of defining the communication link includes defining an Internet communication link between the document provider and the document distribution system controller, and wherein the step of receiving the document includes receiving the document at the document distribution system controller from the document provider via the Internet communication link.

10. The method of claim 3, further comprising the step of:
defining a communication link between the user and the document distribution system controller, and wherein the step of distributing the document includes distributing the document to the user via the communication link.

11. The method of claim 10, wherein the step of defining the communication link includes defining an Internet communication link between the user and the document distribution system controller, and wherein the step of distributing the document includes distributing the document to the user via the Internet communication link.

12. The method of claim 1, wherein the step of registering the document criterion of the user occurs before the step of receiving the document.

13. The method of claim 1, wherein the step of receiving the document includes receiving a data file for the document, and wherein the step of determining if the document satisfies the document criterion includes processing the data file for the document, determining from the data file a content of the document, and comparing the content of the document with the document criterion of the user.

14. The method of claim 1, wherein the step of receiving the document includes receiving an identification for the document, the identification for the document including file location information for the document.

15. The method of claim 1, further comprising the step of:
registering a distribution preference of the user, and wherein the step of distributing the document includes distributing the document to the user in accordance with the distribution preference.

16. The method of claim 15, wherein the step of registering the distribution preference includes registering at least one of a notification preference of the user and a publication preference of the user.

17. A computer-readable medium having computer-executable instructions for performing a method of distributing a document to a user, the method comprising:
registering a document criterion of the user;
receiving the document;
determining if the document satisfies the document criterion of the user, including comparing the document with the document criterion of the user; and
distributing the document to the user if the document satisfies the document criterion of the user.

18. The computer-readable medium of claim 17, wherein registering the document criterion includes registering at least one of a keyword list of the user and a keyword rule of the user, and wherein the method further comprises:
maintaining a master keyword list based on the at least one of the keyword list of the user and the keyword rule of the user, and wherein determining if the document satisfies the document criterion includes comparing the document with the master keyword list.

19. The computer-readable medium of claim 18, wherein the method further comprises:
generating a document keyword list for the document based on a content of the document and the master keyword list, and wherein determining if the document satisfies the document criterion includes comparing the document keyword list with the document criterion.

20. The computer-readable medium of claim 17, wherein registering the document criterion of the user occurs before receiving the document.

21. The computer-readable medium of claim 17, wherein receiving the document includes receiving a data file for the document, and wherein determining if the document satisfies the document criterion includes processing the data file for the document, determining from the data file a content of the document, and comparing the content of the document with the document criterion of the user.

22. The computer-readable medium of claim 17, wherein receiving the document includes receiving an identification for the document, the identification for the document including file location information for the document.

23. The computer-readable medium of claim 17, wherein the method further comprises:
registering a distribution preference of the user, and wherein distributing the document includes distributing the document to the user in accordance with the distribution preference.

24. The computer-readable medium of claim 23, wherein registering the distribution preference includes registering at least one of a notification preference of the user and a publication preference of the user.

25. A system for distributing a document to a user, the system comprising:
a document distribution system controller configured to have a document criterion of the user registered therewith,
wherein the document distribution system controller is adapted to receive the document and compare the document with the document criterion of the user to determine if the document satisfies the document criterion of the user, and wherein the document distribution system controller is adapted to distribute the document to the user if the document distribution system controller determines that the document satisfies the document criterion of the user.

26. The system of claim 25, wherein the document distribution system controller is adapted to compare a content of the document with the document criterion of the user to determine if the document satisfies the document criterion of the user.

27. The system of claim 25, wherein the document criterion of the user includes at least one of a keyword list of the user and a keyword rule of the user.

28. The system of claim 27, wherein the document distribution system controller is adapted to maintain a master keyword list based on the at least one of the keyword list of the user and the keyword rule of the user, and wherein the document distribution system controller is adapted to compare the document with the master keyword list to determine if the document satisfies the document criterion of the user.

29. The system of claim 28, wherein the document distribution system controller is adapted to generate a document keyword list for the document based on a content of the document and the master keyword list, and wherein the document distribution system controller is adapted to compare the document keyword list with the document criterion to determine if the document satisfies the document criterion of the user.
